(19) United States
(12) Patent Application Publication
(10) Pub. No.: US 2010/0253584 A1
(43) Pub. Date: Oct. 7, 2010

(54) Antenna apparatus

(76) Inventors: Wen-Chieh Yang, Tu-Cheng City (TW); Kai Shih, Tu-Cheng City (TW); Yu-Yuan Wu, Tu-Cheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/385,331

(22) Filed: Apr. 6, 2009

(51) Int. Cl. H01Q 21/28

(52) U.S. Cl. 343/725

(57) ABSTRACT

An antenna apparatus includes a housing defining a plurality of walls and a plurality of included angle spaces between the walls. An inner surface of one of the walls is configured a telecommunication antenna. One of the included angle spaces opposite to the wall on which the telecommunication antenna is configured a global positioning system antenna. A broadcast receiving antenna positions in the housing and between the telecommunication antenna and the global positioning system antenna. Because the telecommunication antenna and the global positioning system antenna position away from each other, the interference therebetween will be reduced.

### BACKGROUND OF THE INVENTION

1. Field of the Invention

The present invention relates to an antenna, more specifically, to an antenna apparatus capable of reducing interference among diverse antennas configured therein.

2. The Related Art

According to the progress of the communication technology, the key development is the transfer from wired to wireless communication. Many kinds of wireless communication systems are used nowadays. Additionally, wireless communication has become one of the essential functions in a vehicle.

Thus, an antenna apparatus also becomes a necessary component for the vehicles. For operating every kind of wireless communication system in the vehicle, various antennas are configured at different locations of the vehicles body respectively. The distributive arrangement can prevent the diverse antennas from interfering each other. However, it is inconvenient to integrate several antennas and likely to damage the vehicle body.

For preventing vehicle body from being damaged, it is better to configure the diverse antennas together in a housing and then configure the housing on the vehicle body. However, it may causes interference among the diverse antennas. Therefore, it is a key development to configure the diverse antennas together to prevent the vehicle body from being damaged by configuring, and reduce interference among the diverse antennas.

### SUMMARY OF THE INVENTION

An object of the present invention is to provide an antenna apparatus including a housing, a telecommunication antenna, a global positioning system antenna and a broadcast receiving antenna. The housing defines a plurality of walls and a plurality of included angle spaces defined between the walls.

The telecommunication antenna positions on an inner surface of one of the walls. The global positioning system antenna positions at one of the included angle spaces opposite to the wall on which the telecommunication antenna positioned. The broadcast receiving antenna positions in the housing and between the telecommunication antenna and the global positioning system antenna.

Due to the telecommunication antenna, the global positioning system antenna and the broadcast receiving antenna together position in the housing, it can conveniently configure the housing on a vehicle body and prevent the vehicle body from being damaged. Due to the telecommunication antenna and the global positioning system antenna keep away from each other, the interference therebetween is reduced.

### BRIEF DESCRIPTION OF THE DRAWINGS

The present invention will be apparent to those skilled in the art by reading the following description of preferred embodiments thereof, with reference to the attached drawings, in which:

FIG. 1 shows the top view of an antenna apparatus when the housing is unfolded according to the present invention;

FIG. 2 shows the top view of the antenna apparatus according to the present invention;

FIG. 3 shows the efficiency table of a telecommunication antenna of the antenna apparatus according to the present invention;

FIG. 4 shows the gain variation of field pattern of E-plane of a GPS antenna of the antenna apparatus according to the present invention; and

FIG. 5 shows the gain variation of field pattern of H-plane of the GPS antenna of the antenna apparatus according to the present invention.

### DETAILED DESCRIPTION OF THE PREFERRED EMBODIMENT

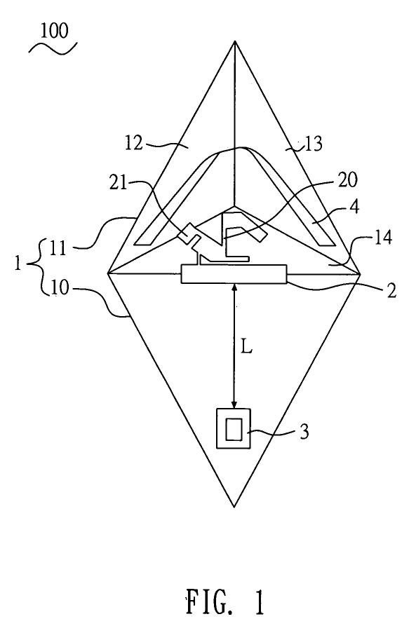

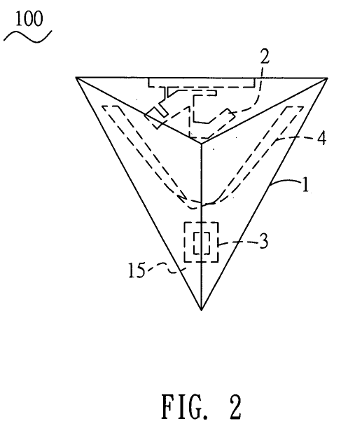

Please refer to FIG. 1 and FIG. 2. A preferred embodiment of an antenna apparatus 100 includes a housing 1, a telecommunication antenna 2, a global positioning system (GPS) antenna 3 and a broadcasting receiving antenna 4. The housing 1 is substantially of a triangular taper shape and includes a base 10 and a cover 11 assembled to the base 10. In FIG. 1, the housing 1 is shown as an unfolded status that the communication antenna 2 positioned at the edge between the base 10 and a wall of the cover 11

The telecommunication antenna 2, the GPS antenna 3 and the broadcast receiving antenna 4 together position in the housing 1. A bottom portion of the base 10 of the housing 1 is configured with a magnet (not shown in figures) for conveniently attaching the antenna apparatus 100 on a vehicle body (not shown in figures) or separating the antenna apparatus 100 from the vehicle body. Furthermore, it can prevent the vehicle body from being damaged.

The cover 11 includes a first wall 12, a second wall 13 connecting to the first wall 12, and a third wall 14 connecting to the first wall 12 and the second wall 13. The base 10, the first wall 12 and the second wall 13 together form an included angle space 15 opposite to the third wall 14.

The telecommunication antenna 2 positions on an inner surface of the third wall 14 of the cover 11. The telecommunication antenna 2 has a first radiating portion 20 to resonate at a lower frequency range and a second radiating portion 21 to resonate at a higher frequency range. For example, the lower frequency range covers GSM 850 MHz band and EGSM 900 MHz band, and the higher frequency range covers DCS 1800 MHz band, PCS 1900 MHz band and WCDMA 2100 MHz band.

Because the operation frequency of the GPS antenna 3 is about 1575 MHz and near the higher frequency range of the telecommunication antenna 2, it will arise the interference between the GPS antenna 3 and the telecommunication antenna 2. The GPS antenna 3 and the telecommunication antenna 2 need to keep a distance L to avoid the interference. Thus, the GPS antenna 3 positions in the included angle space 15. Preferably the distance L from GPS antenna 3 to the third wall 14 of the cover 11 is 89 millimeters.

Because the operation frequency of the broadcast receiving antenna 4 is between hundreds KHz and hundreds MHz, which is far away from the operation frequencies of the telecommunication antenna 2 and the GPS antenna 3, so it will not cause the interference between the broadcast receiving antenna 4 and the GPS antenna 3 and the interference between the broadcast receiving antenna 4 and the telecommunication antenna 2. Thus, the broadcast receiving antenna 4 can be positioned between the telecommunication antenna 2 and the GPS antenna 3.

In this embodiment, the broadcast receiving antenna 4 is in an elongated shape and positions on inner surfaces of the first wall 12 and the second wall 13 of the cover 11. The broadcast receiving antenna 4 can operate at amplitude modulation band (AM), frequency modulation band (FM), ultra high frequency band (UHF), very high frequency band (VHF), digital video broadcast band (DVB) and digital audio broadcast, band (DAB). Furthermore, the broadcast receiving antenna 4 can be a chip antenna.

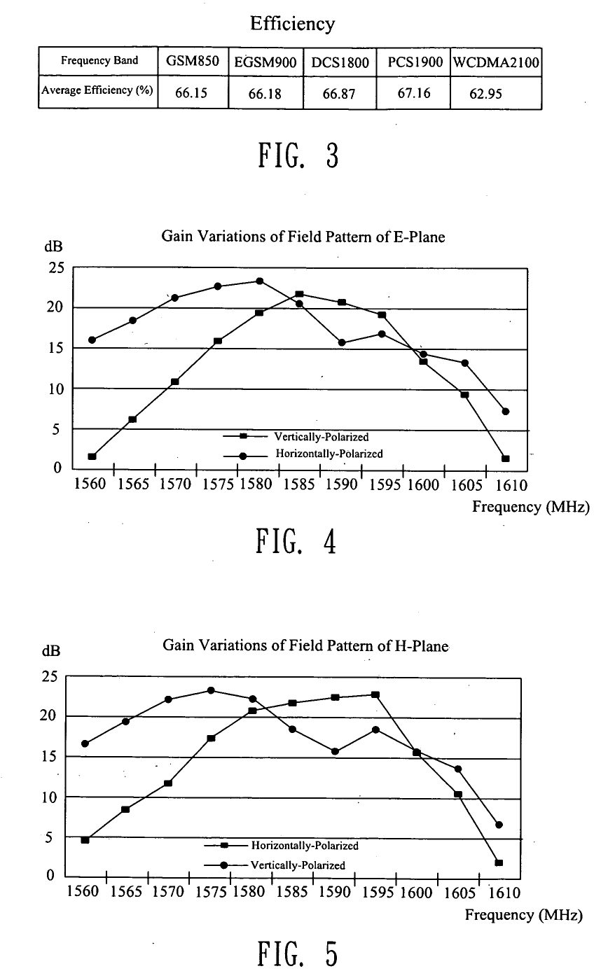

Please refer to FIG. 3, which shows the efficiency of the telecommunication antenna 2. The telecommunication antenna 2 obtains 66.15 percents of efficiency at GSM 850 MHz band, 66.18 percents of efficiency at EGSM 900 MHz band, 66.87 percents of efficiency at DCS 1800 MHz band, 67.16 percents of efficiency at PCS 1900 MHz band and 62.95 percents of efficiency at WCDMA 2100 MHz band. It obviously shows the telecommunication antenna 2 has a preferable efficiency.

Please refer to FIG. 4 and FIG. 5. FIG. 4 shows the gain variations of field pattern of E-plane of the GPS antenna 3. FIG. 5 shows the gain variation of field pattern of H-plane of the GPS antenna 3. It shows that the gain variations of field pattern between horizontally-polarized and vertically-polarized in H-plane and E-plane are obviously small. It means the GPS antenna 3 has a preferable gain.

As described above, the telecommunication antenna 2, the GPS antenna 3 and the broadcast receiving antenna 4 together position in the housing 1 to conveniently configure the antenna apparatus 100 on the vehicle body and prevent the vehicle body from being damaged by configuring. The telecommunication antenna 2 and the GPS antenna 3 respectively positioned at the inner surface of the third wall 14 and the included angle space 15 keep a distance therebetween to reduce the interference.

Furthermore, the present invention is not limited to the embodiments described above; diverse additions, alterations and the like may be made within the scope of the present invention by a person skilled in the art. For example, respective embodiments may be appropriately combined.

What is claimed is:

1. An antenna apparatus, comprising:
a housing defining a plurality of walls and a plurality of included angle spaces between the walls;
a telecommunication antenna positioning on an inner surface of one of the walls;
a global positioning system antenna positioning at one of the included angle space opposite to the wall on which the telecommunication antenna positioning;
a broadcast receiving antenna positioning in the housing and between the telecommunication antenna and the global positioning system antenna.

2. The antenna apparatus as claimed in claim 1, wherein the housing comprises a base and a cover assembled to the base, the cover comprises a first wall, a second wall connecting to the first wall and a third wall connecting to the first and second walls, the base and the first and second walls form an included angle space opposite to the third wall, the telecommunication antenna positions on an inner surface of the third wall and the global positioning system antenna positions at the included angle space.

3. The antenna apparatus as claimed in claim 2, wherein the broadcast receiving antenna positions on inner surfaces of the first and second walls.

4. The antenna apparatus as claimed in claim 2, wherein the housing is in a shape of triangular taper.

5. The antenna apparatus as claimed in claim 1, wherein the broadcast receiving antenna operates at frequency modulation band.

6. The antenna apparatus as claimed in claim 1, wherein the broadcast receiving antenna is in an elongated shape.

7. The antenna apparatus as claimed in claim 1, wherein a distance between the global positioning system antenna and the telecommunication antenna is less than 90 millimeters.

8. The antenna apparatus as claimed in claim 1, wherein the telecommunication antenna comprises a first radiating portion resonating at a lower frequency range and a second radiating portion resonating at a higher frequency range.
